(19) United States
(12) Patent Application Publication
(10) Pub. No.: US 2006/0229377 A1
(43) Pub. Date: Oct. 12, 2006

(54) Photopolymerizable single-component crown and bridge material

(75) Inventors: Alexander Bublewitz, Herborn (DE); Matthias Suchan, Hachenburg (DE); Jens-Peter Reber, Meinerzhagen (DE)

Correspondence Address: WILLIAM COLLARD;COLLARD & ROE, P.C., 1077 NORTHERN BOULEVARD, ROSLYN, NY, 11576, US

(73) Assignee: Kettenbach GmbH & Co. KG

(21) Appl. No.: 11/392,418

(22) Filed: Mar. 29, 2006

(30) Foreign Application Priority Data
Apr. 11, 2005 (DE) 10 2005 016 762.4

(51) Int. Cl. C08F 2/46

(52) U.S. Cl. 522/7

(57) ABSTRACT

A photopolymerizable single-component dental material, that is useful as a temporary, photopolymerizable single-component crown and bridge material. The material contains at least one compound that can be polymerized by means of photoinitiation, at least one photoinitiator, and filler, if necessary.

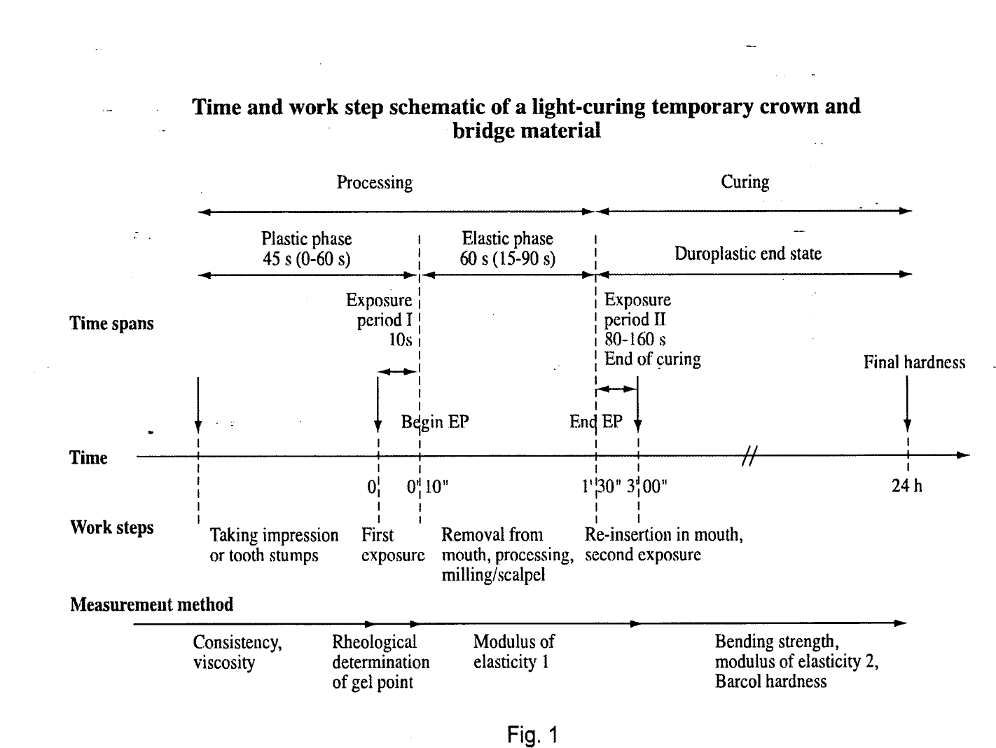

### BACKGROUND OF THE INVENTION

1. Field of the Invention

The present invention relates to a photopolymerizable single-component dental material, particularly a temporary, photopolymerizable single-component crown and bridge material, containing at least one compound that can be polymerized by means of photoinitiation, at least one photoinitiator, and filler, if necessary.

2. The Prior Art

A person skilled in the art is familiar with a number of chemically curing systems for temporary crown and bridge material. Such materials usually contain one or more monomers, preferably monomers that can be radically polymerized, fillers, and a polymerization initiator. In order to avoid premature polymerization during storage, these materials must necessarily be formulated as two-component systems, with the polymerization initiator in the one component, and the monomer in the other component. Aside from the effort and expense in terms of production technology and logistics that is necessarily connected with the two-component systems, a significant disadvantage of these chemically curing two-component materials lies in the fact that the two components must be mixed with one another in precise amount ratios before being used, in order to achieve curing to produce a material having the desired properties, since even very small mixing errors can impair the quality of the end material. In order to avoid mixing errors or non-homogeneous mixing, these materials must therefore regularly be mixed with one another using complicated and expensive mixing and metering devices, before being used. Another disadvantage of the chemically curing two-component materials lies in the lack of reproducibility of the curing process, which is due to the fact that the polymerization is dependent on ambient conditions, so that variations in relative humidity and, in particular, in temperature can negatively influence the processing time and the final properties of the cured material.

As an alternative to two-component crown and bridge materials that cure purely chemically, dual-curing two-component materials have already been proposed. These materials first make a transition into a rubber-elastic state, after the two components have been mixed together, as a result of a polymerization reaction, in which they can be worked on by the dentist, and then subsequently cure to form the final product by means of photopolymerization. However, these systems also have the disadvantages that are inherent in the two-component systems.

For this reason, crown and bridge materials that cure purely with light, i.e. photopolymerizable materials, have been offered on the market, which are formulated in single-component manner. In addition to avoiding the mixing problems, these materials also have the advantage of curing independently of the ambient conditions, such as humidity and moisture, to a great extent.

Photopolymerizable dental compositions for the production of final crowns and bridges, in other words not temporary ones, by means of a standard layer build-up technique, containing photopolymerizable polyfunctional (meth)acrylates, organic and/or inorganic fillers, and a photoinitiator system, are known from European Patent No. EP 0 166 009 A1, whereby a ketone and/or α,β-diketone in combination with an amine or amine salt is/are preferably used as a photoinitiator. These dental compositions have a viscous consistency and are cured in layers, when used as crown and bridge material, initiated by irradiation with visible light in the range of 350 to 700 nm. However, these materials are not suitable as (temporary) crown and bridge material.

For the production of temporary crowns and bridges, usually an impression of the corresponding jaw is first made with a suitable impression material, in order to establish the original situation and the shape of the teeth to be prepared. Subsequently, the teeth in question are prepared, by grinding them down, to produce tooth stumps that later serve as the base for the crowns or bridge. Then the impressions of the teeth to be prepared are filled with the temporary crown and bridge material, in the impression that was taken. The impression that has been prepared in this manner is now repositioned on the tooth stumps, before curing of the shaped temporaries is initiated. After a rubber-elastic time phase has been reached, but before final curing, the impression with the shaped temporaries is removed, before the crown and bridge material then cures to its final state, outside of the patient's mouth.

Because of its viscous consistency, the dental material disclosed in European Patent No. EP 0 166 009 A1 cannot penetrate into smaller interstices of the tooth impressions in the impression, so that this results in imprecise reproduction of the tooth to be prepared. Furthermore, during repositioning on the jaw, compression, straining, or stretching of the impression material can occur, because of the high viscosity of the material, and therefore the outside contours of the temporary crown can be enlarged. This in turn results in bite elevations and malfunctions during chewing stress, so that the dentist is forced to grind the temporary crown down, resulting in increased time expenditure. In addition, the mechanical properties of the cured material require improvement.

Another disadvantage of the compositions disclosed in European Patent No. EP 0 166 009 A1 results from the fact that they are polymerized by a layer build-up technique. However, in this layer build-up technique, no elastic phase that is absolutely necessary to produce a temporary crown and bridge material is provided, i.e. there is no time period during which the material demonstrates elastic properties for a sufficiently long period of time, so that it can be removed from the patient's mouth without any undesirable, permanent deformations, but is not yet so strongly cured that the material adheres to the teeth too strongly, or anchors itself in interstices between the teeth and can no longer be released from the undercuts, or breaks when it is removed from the mouth. For this reason, as well, these materials are unsuitable as temporary crown and bridge material.

Furthermore, the compositions disclosed in European Patent No. EP 0 166 009 A1 demonstrate a through-curing depth of only 2 mm after exposure with visible light between 400 and 600 nm for five minutes. This is too slight for use as temporary crown and bridge material, in which through-curing depths of at least 5 mm are required. Aside from this, the through-curing time of the aforementioned materials, at five minutes, is too long and therefore not appropriate for dental practices.

European Patent No. EP 0 166 009 A1 furthermore discloses the use of organic and/or inorganic fillers and combinations thereof. Non-silanated or silanated pyrogenic silicic acids as well as dental glass types are described as inorganic fillers, and cross-linked mono(meth)acrylates, di(meth)acrylates, or poly(meth)acrylates are described as organic fillers. However, the addition of such fillers or combinations of fillers results in poor mechanical properties of the cured material, and in an overly tough consistency for use as a temporary crown and bridge material, because of the swelling of the organic fillers or the great BET surfaces of the pyrogenic silicic acids. Another disadvantage of these materials lies in the high raw material costs, particularly when using expensive dental glass types.

Fundamentally, it is difficult for a dentist, in connection with the known materials for temporary crowns or bridges, to remove them from the mouth at the correct moment to continue working on them, after the first adaptation on the prepared tooth stump. With chemical curing initiated by mixing a base component with a catalyst component, this curing process proceeds continuously. In this connection, the temporary crown or bridge must remain in the patient's mouth until it can be removed in one piece, i.e. without tearing or undergoing any other plastic deformation. At the same time, excess portions of the material, which have run into undercuts, such as interstices between teeth, for example, must still be elastically deformable, since otherwise the temporary is extremely difficult to remove after it has cured completely. With auto-polymerizing systems, the correct point in time for first removal of the temporary and subsequent finishing can therefore not be clearly determined.

### SUMMARY OF THE INVENTION

It is therefore the object of the present invention to make available a single-component dental material that cures exclusively with light, particularly a single-component (temporary) crown and bridge material, which is given its external shape by individually produced shaping means, such as impression trays, impression material, trays, or the like, does not demonstrate the aforementioned disadvantages and, in particular, can be worked into (temporary) crowns and bridges in simple and reproducible manner.

This task is accomplished, according to the invention, by means of a single-component dental material that cures exclusively with light. Preferably this material, in a first, plastic, non-polymerized state, has a viscosity between 10 Pa·s and 100,000 Pa·s, preferably between 10 Pa·s and 10,000 Pa·s, particularly preferably between 20 Pa·s and 1,000 Pa·s, and very particularly preferably between 20 Pa·s and 600 Pa·s, and/or a consistency (analogous to ISO 4823) between 50 mm and 15 mm, preferably between 50 and 18 mm, particularly preferably between 47 mm and 21 mm, and very particularly preferably between 45 and 24 mm. After a first initiation of the photopolymerization, the material makes a transition into an elastic state, which is understood, in the sense of the invention, as an elastically deformable state, in which the material has a modulus of elasticity between 1 and 50 MPa, whereby the elastic state is maintained over a period of at least 15 seconds, before the dental material reaches a final, duroplastic state in which the material reaches a modulus of elasticity of at least 1,000 MPa and a bending strength of at least 90 MPa. This may also require a second photoinitiation. This guarantees that the material is sufficiently capable of flow before the photoinitiation, in order to penetrate even into smaller interstices of the impression, and to be able to assure precise reproduction of the tooth impressions and tooth fissures in the impression tray. In addition, compression, straining, or stretching of the impression material can be reliably avoided during repositioning on the jaw, along with any accompanying enlargement of the outside contours of the (temporary) crowns. During the elastic state, i.e. the elastic phase, the material demonstrates sufficiently great resilience and shape stability so that it can be removed from the patient's mouth without risk and without any undesirable deformation, and then can cure to the final state, outside or inside the patient's mouth, if necessary after final finishing. Another advantage of the material lies in the fact that the dentist or dental technician can determine the start of photopolymerization himself/herself, by means of the exposure, and thereby the time point at which the elastic phase is reached. As an advantage in comparison with the known powder/liquid systems that cure by means of auto-polymerization, or the paste/paste systems that cure by means of peroxide polymerization, the dental material according to the invention allows photoinduced, fast final curing of the temporary, by means of a dental lamp, on the tooth stump in the patient's mouth, thereby preventing free polymerization shrinkage and increasing direct fit accuracy. In addition, the dental material according to the invention demonstrates sufficient through-curing depth.

The (temporary) crown and bridge material can be formulated in tooth color, and opaque/translucent.

The dental material cures, proceeding from its plastic starting state, in which it is capable of flow, and demonstrates a viscosity between 10 Pa·s and 100,000 Pa·s, preferably between 10 Pa·s and 10,000 Pa·s, particularly preferably between 20 Pa·s and 1,000 Pa·s, and very particularly preferably between 20 Pa·s and 600 Pa·s, and/or a consistency (analogous to ISO 4823) between 50 mm and 15 mm, preferably between 50 and 18 mm, particularly preferably between 47 mm and 21 mm, and very particularly preferably between 45 and 24 mm and, after initiation of the photopolymerization, passing through an elastic phase of at least 15 seconds. The total curing time and the length of the plastic and elastic phase, and therefore the total processing time of the dental material can be influenced by the intensity of the light used, the irradiation period, as well as the wavelength of the light used. In this connection, the curing can take place by means of one photoinitiation, or alternatively to this, by means of two or more photoinitiations. For example, the dental material can contain a photoinitiator and be irradiated with radiation at a suitable intensity in a first step, then pass through the elastic phase, before final curing is initiated or accelerated by means of a second irradiation. Alternatively to this, the dental material can contain two different photoinitiator systems, which are activated by radiation at different wavelengths. In this situation, the dental material is formulated in such a manner that it first reaches and passes through an elastic phase after a first irradiation with a first light source, before final curing is initiated by means of a second irradiation with a second light source, which emits light at a different wavelength from the first. In this case, the user can adjust the processing time himself/herself.

Preferably, the dental material is formulated in such a manner that photoinduced, final curing is initiated using a dental lamp such as that disclosed in the overview articles Dental Spiegel 6/98, p. 39 ff.; ZWR 111, year 2002, No. 6, p. 309 ff., and Dental Magazin 2/2004, p. 94 ff., and a crown and bridge material having the aforementioned properties is achieved within 5 to 240 seconds, preferably 10 to 180 seconds, particularly preferably 10 to 160 seconds, and very particularly preferably 10 to 120 seconds.

In order to avoid tissue injuries in the patient's mouth, a photoinitiator system is preferably used that is activated with visual light, in other words light having a wavelength between 350 and 700 nm, and preferably between 370 and 550 nm.

In one embodiment, only part of the exposure period and/or exposure intensity that would actually be necessary for complete curing of the (temporary) crown and bridge material is radiated in during a first exposure step, in order to achieve the elastic phase. Surprisingly, it has been shown, that only part of the photoinitiator is activated by the light radiated in during the first exposure step, and thereby converted to radicals and used up in this manner, by means of radiating in an exposure intensity and/or exposure period that is less than that required for complete curing. Because only part of the photoinitiator generates radicals, only part of the methacrylate and epoxy oligomers is polymerized. In this manner, a marked elastic phase, which lasts for a period between 15 and 90 seconds, preferably between 15 and 75 seconds, particularly preferably between 15 and 60 seconds, and very particularly preferably between 30 and 60 seconds, is obtained. Furthermore, it has surprisingly been shown that the remaining, unused photoinitiator amount is therefore available for final curing to a duroplastic state, in a second exposure step.

Furthermore, it has been proven to be advantageous if the single-component material according to the invention has a modulus of elasticity, measured analogous to ISO 10477, between 2 MPa and 45 MPa, preferably between 2 MPa and 35 MPa, and particularly preferably between 2 MPa and 25 MPa, during the elastic phase. In this way, deformations during removal of the crown and bridge material from the patient's mouth are reliably avoided.

In order to ensure a sufficiently long processing time during the elastic phase, the material is preferably formulated in such a manner that the increase in modulus of elasticity that starts after the first photoinitiation, if applicable, amounts to between 0.5 and 0.0001 MPa/sec, preferably between 0.3 and 0.001 MPa/sec, particularly preferably between 0.25 and 0.002 MPa/sec, and very particularly preferably less than or equal to 0.21 MPa/sec, during the elastic phase.

In order to guarantee sufficient stability of the subsequent crown or bridge, the single-component dental material is formulated so that it has a modulus of elasticity, in the bending test, of greater than or equal to 1,000 MPa, preferably greater than or equal to 2,000 MPa, particularly preferably greater than or equal to 2,500 MPa, and very particularly preferably greater than or equal to 3,000 MPa, and/or a bending strength (analogous to ISO 10477) greater than or equal to 90 MPa, preferably greater than or equal to 100 MPa, and particularly preferably greater than or equal to 110 MPa. Furthermore, preferably the Barcol hardness of the cured material, as an alternative to the aforementioned properties or in addition thereto, is greater than or equal to 40, preferably greater than or equal to 45, particularly preferably greater than or equal to 50, and particularly preferably greater than or equal to 55.

Preferably, the single-component dental material contains
a) 0.01 to 3 wt.-%, preferably 0.05 to 2 wt.-%, particularly preferably 0.1 to 1 wt.-%, and very particularly preferably 0.2 to 0.5 wt.-% of at least one photoinitiator,
b) 0 to 10 wt.-%, preferably 0.00001 to 1 wt.-%, and particularly preferably 0.0001 to 0.1 wt.-% of at least one co-photoinitiator,
c) 0.01 to 1.0 wt.-%, preferably 0.05 to 0.5 wt.-%, and particularly preferably 0.01 to 0.5 wt.-% of at least one photoretarder or stabilizer,
d) 0.1 to 99 wt.-%, preferably 5 to 80 wt.-%, and particularly preferably 20 to 60 wt.-% of at least one photopolymerizable compound,
e₁) 0 to 80 wt.-%, preferably 0 to 70 wt.-%, particularly preferably 0 to 50 wt.-%, and very particularly preferably 0.1 to 30 wt.-% of at least one nanoparticle e₁), preferably having a particle size distribution between 5 and 35 nm,
e₂) 0 to 60 wt.-%, preferably 0 to 50 wt.-%, particularly preferably 0 to 40 wt.-%, and very particularly preferably 0.1 to 30 wt.-% of at least one reinforcing filler having a BET surface of at least 50 m²/g,
e₃) 0 to 70 wt.-%, preferably 0 to 60 wt.-%, particularly preferably 0 to 55 wt.-%, and very particularly preferably 0.1 to 50 wt.-% of at least one semi-reinforcing filler having a BET surface of 35 m²/g±10 m²/g,
e₄) 0 to 90 wt.-%, preferably 0 to 85 wt.-%, particularly preferably 0.1 to 80 wt.-% of at least one non-reinforcing filler, preferably having a grain size of 0.1 μm to 30 μm, preferably 0.4 μm to 15 μm, particularly preferably 0.4 μm to 7 μm (Ullmann Enzyklopadie der technischen Chemie [Ullmann's Encyclopedia of Technical Chemistry], Vol. 21, p. 523), and
f) 0-10% additives.

Possible photoinitiators a) that can be used are all the compounds known to a person skilled in the art for this purpose, whereby monoketones and, in particular, diketones, such as 9-fluorenone, have proven themselves to be particularly suitable. Good results are obtained, in particular, with camphor quinone as a photoinitiator. Since a color change of the dental material from an intense yellow tone to a lighter color can be observed after the first photoinitiation when using camphor quinone, this makes a good way of checking that the temporary has cured through completely possible. Likewise, although this is less preferred, a compound selected from the group consisting of monoacyl and diacyl phosphine oxides, diazonium compounds, sulfonium compounds, iodonium compounds, derivatives of cyclopentadienyl/iron/arsenic complexes, titanocenes, Darocure 4265 (Ciba Geigy), Lucirin TPO (BASF), ferrocenes, and any desired combinations thereof can be used as the photoinitiator a). Furthermore, the substances described in Austrian Patent No. AT 412 346 B, European Patent Nos. EP 0 475 239 A2, EP 0 728 790 A1, EP 1 287 805 B1, German Patent No. DE 19 506 B4, International Publication Nos. WO 99/62460, WO 03/066688 A1, and in the book “Photoinitiation, Photopolymerization and Photocuring—Fundamentals and Applications” by J. P. Fouassier, Hanse Verlag 1995, p. 84-90, have proven themselves to be suitable photoinitiators a).

Also, fundamentally, all of the compounds known to a person skilled in the art for this purpose can be used as co-photoinitiators b), whereby reduction agents, in particular, such as aliphatic or aromatic amines, have proven themselves to be suitable. Examples of suitable co-photoinitiators are tertiary amines, such as e.g. trihexyl amine, or salts of tertiary amines, particularly N,N-diethanol methyl amine, triethanol amine or (meth)acrylates thereof, such as 2-dimethylaminoethyl (meth)acrylate, 3-dimethylaminopentyl (meth)acrylate, 3,5,N,N-tetramethyl aniline, N-methyl diphenyl amine, 3-methyl diphenyl amine, (meth)acrylic acid-2-(dimethylamino)ethyl ester (DMAEMA), p-toluyl diethanol amine, N,N-dimethyl aniline, sodium-4-toluene sulfinate, N-2-cyanoethyl-N-methyl aniline (CEMA), ethyl-4-dimethylaminobenzoate (ED-MAB), 2-ethyl hexyl-4-dimethylaminobenzoate, p-toluidine, p-dimethyl toluidine, polyamines, such as N,N,N′,N′-tetraalkyl alkylene diamine, sulfidimides, as well as the amines disclosed in the U.S. Pat. Nos. 4,439,380, 4,437,836, and 4,816,495, N,N-bis(2-hydroxy ethyl)-p-toluidine, methyl-4-dimethylaminobenzoate, and/or isoamyl-4-dimethylaminobenzoate. Likewise, although they are less preferred, barbituric acid, barbituric acid derivatives, and malonyl sulfamides can be used for this purpose, as well as the co-photoinitiators disclosed in the patents cited with regard to the photoinitiators a).

The light-curing crown and bridge material according to the invention can contain, in particular, a compound selected from the group consisting of polymer trimethyl dihydroquinoline, diphenyl derivatives, phenothiazine, phenyl-α-naphthyl amine, 4,4-methylene-bis-2,6-di-tert-butyl phenol, 3,5-di-tert-butyl-4-hydroxytoluene (BHT), 3-tert-butyl-4-hydroxyanisol (BHA), 4-methoxy phenol (hydroxyanisol), 2-(2′-hydroxy-5-methyl phenyl)-benzotriazol, 3,5-di-tert-butyl-4-hydroxyanisol, hydroquinone, p-benzophenone, p-butyl hydroxytoluene, 2-hydroxy-4-methoxy benzophenone, and any desired combinations thereof as photoretarders and/or stabilizers c). Particularly suitable examples of such compounds are the products commercially available from the company Ciba-Geigy, Tinuvin® P, Tinuvin® 327, Tinuvin® 328, Tinuvin® 384, Tinuvin® 900, Tinuvin® 928, Tinuvin® 1130, Tinuvin® 400, Tinuvin® 123, Tinuvin® 144, Tinuvin® 292, Tinuvin® 111 FP, Tinuvin® 770, Irganox® 1010, Irganoxe 1035, Irganox® 1076, Irganox® B 225, Irganox® B 900, Irganox® B 921, Irganox® LM 91, Irganox® MD 1024, Irgacor® 153, Irgacor® 252 LD, Irgacor® 252 FC, Irgacor® 1405, Irgacor® 1930, Uvitex® OB, Uvitex® NFW liquid, Irgarol® 1051/1071, Irgafos® 38, Irgafos® 168, Irgafos® 153, as well as the products Albrite® triphenyl phosphite, triolyl phosphite, tris(2-chloroethyl) phosphite, triisopropyl phosphite, tributyl phosphite, tri(2-ethyl hexyl) phosphite, and triisooctyl phosphite from the company Rhodia, as well as Uvinul® 3000 from the company BASF.

According to a first embodiment of the present invention, the dental material contains a photocatalyst system consisting of at least one photoinitiator a) and at least one photoretarder c), but no co-photoinitiator b), whereby the molar ratio of photoinitiator a) to photoretarder c) preferably amounts to between 0.5:1 and 250:1, particularly preferably between 1:1 and 150:1, very particularly preferably between 1:1 and 100:1, and most particularly preferably between 1:1 and 50:1. In this embodiment, camphor quinone and/or Lucirin TPO are preferably used as photoinitiator a), and a compound selected from the group consisting of hydroxyanisol, di-tert-butyl hydroxytoluene, di-tert-butyl hydroxyanisol, and any desired combinations thereof, are used as photoretarder c).

According to a second embodiment of the present invention, the dental material contains a photocatalyst system consisting of at least one photoinitiator a), at least one co-photoinitiator b), and at least one photoretarder c), whereby the molar ratio of photoinitiator a) and co-photoinitiator b) amounts to between 1:1 and 1:5, preferably between 1:1 and 1:4, as well as particularly preferably between 1:1 and 1:3 and, at the same time, the ratio of photoinitiator a) to photoretarder c) amounts to between 1:1 and 1:25, preferably between 1:1 and 1:10, as well as particularly preferably between 1:1 and 1:5. In this embodiment, camphor quinone and/or Lucirin TPO are preferably used as photoinitiator a), 4-dimethylaminobenzoic acid ethyl ester and/or 4-cyanoethyl aniline are used are co-photoinitiator b), and a compound selected from the group consisting of hydroxyanisol, di-tert-butyl hydroxytoluene, di-tert-butyl hydroxyanisol, and any desired combinations thereof, are used as photoretarder c).

According to a third embodiment of the present invention, the dental material contains a photocatalyst system consisting of at least one photoinitiator a), at least one co-photoinitiator b), and at least one photoretarder c), whereby the molar ratio of photoinitiator a) to co-photoinitiator b) amounts to between 250:1 and 1:1, preferably between 200:1 and 3:1, as well as particularly preferably between 150:1 and 5:1 and, at the same time, the ratio of photoinitiator a) to photoretarder c) amounts to between 75:1 and 1:1, preferably between 50:1 and 1:1, as well as particularly preferably between 30:1 and 1:1. In this embodiment, camphor quinone and/or Lucirin TPO are preferably used as photoinitiator a), 4-dimethylaminobenzoic acid ethyl ester and/or 4-cyanoethyl aniline are used are co-photoinitiator b), and a compound selected from the group consisting of hydroxyanisol, di-tert-butyl hydroxytoluene, di-tert-butyl hydroxyanisol, and any desired combinations thereof, are used as photoretarder c).

With each of the three aforementioned special embodiments, dental materials are obtained that have a particularly marked elastic phase after photoinitiation.

As the photopolymerizable compound d), the dental material according to the invention can fundamentally contain any and all compounds known to a person skilled in the art for this purpose. In particular, good results are achieved with compounds selected from the group consisting of (meth)acrylate monomers, oligomers having at least two (meth)acrylate groups, and polymers having at least two (meth)acrylate groups. Examples of suitable compounds from this group are alkyl (meth)acrylates, cycloalkyl (meth)acrylates aralkyl (meth)acrylates and 2-hydroxyalkyl (meth)acrylates, such as hydroxypropyl (meth)acrylate, hydroxyethyl (meth)acrylate, isobornyl acrylate, isobornyl (meth)acrylate, butyl glycol (meth)acrylate, acetyl glycol (meth)acrylate, triethylene glycol di(meth)acrylate, polyethylene glycol di(meth)acrylate, 2-phenyl ethyl (meth)acrylate, 2-ethyl hexyl (meth)acrylate, cyclohexyl (meth)acrylate, lauryl (meth)acrylate, and hexane diol di(meth)acrylate, 1,4-butane diol di(meth)acrylate, 1,6-hexane diol di(meth)acrylate, 1,12-dodecane diol di(meth)acrylate, trimethylopropane tri(meth)acrylate, diurethane di(meth)acrylate, ethoxylated bisphenol A di(meth)acrylate w/2 EO units, ethoxylated bis-phenol di(meth)acrylate A w/10 EO units, allyl (meth)acrylate, ethylene glycol di(meth)acrylate, diethylene glycol di(meth)acrylate, triethylene glycol (meth)acrylate, tetraethylene glycol (meth)acrylate, polyethylene glycol (meth)acrylate 200, polyethylene glycol (meth)acrylate 400, polyethylene glycol (meth)acrylate 600, polyethylene glycol (meth)acrylate 1000, 1,3-butane diol di(meth)acrylate, MIRAMER® M200, MIRAMER® M202, MIRAMER® M210, MIRAMER® M220, MIRAMER® M222, MIRAMER® M280, MIRAMER® M281, MIRAMER® M284, MIRAMER® M2101, MIRAMER® M2301, MIRAMER® M216, MIRAMER® M270, MIRAMER® M282, MIRAMER® M286, MIRAMER® M300, MIRAMER® M320, MIRAMER® M340, MIRAMER® M3130, MIRAMER® M3160, MIRAMER® M410, MIRAMER® M4004, MIRAMER® M600, MIRAMER® M360, MIRAMER® M3190, MIRAMER® M420, (meth)acrylate/oligomer resins, as they are disclosed in International Application No. PCT/US96/15942 and German Patent No. DE 19 736 471, epoxy monomers, oligomers, and resins, as they are disclosed in International Application No. PCT/US98/20836, as well as vinyl ether monomers, oligomers, and resins, as they are disclosed in European Patent No. EP 1 267 797.

The nanoparticles e₁) that are preferred according to the invention are preferably produced from water glass by way of a brine/gel method, and are monodisperse (not aggregated or agglomerated) spherical, silanated SiO₂ nanoparticles (e.g. TiO₂ and ZrO₂), particularly preferably having a very narrow particle size distribution between 5 and 35 nm.

The production of the aforementioned nanoparticles preferably takes place in binders, such as e.g. bisphenol A diglycidyl di(meth)acrylate, triethylene glycol di(meth)acrylate, urethane di(meth)acrylate (UDMA), trimethylol propane tri(meth)acrylate, and alkoxylated pentaerytritol tetra(meth)acrylate with a content in the aforementioned binder between 10 and 60 wt.-%, preferably between 20 and 50 wt.-% amorphous silicon dioxide. This mixture is present as a colloidal dispersion.

Reinforcing fillers e₂) that are particularly suitable are highly disperse, active fillers having a BET surface of at least 50 m²/g. Those having an individual particle size in the nanometer range (preferably 7-40 nm) are particularly suitable, which can be present as aggregates (preferably approximately 100-800 nm) and/or agglomerates (preferably 10-200 μm). Preferably, the at least one reinforcing filler is a substance selected from the group that consists of aluminum hydroxide, zinc oxide, titanium dioxide, zirconium oxide, silicon dioxide, precipitated silicic acid, pyrogenic silicic acid, and combinations thereof, whereby particularly good results are obtained, in particular, with silanated silicic acid. Particularly preferably, γ-methacryloxypropyl trimethoxysilane and/or α-methacryloxymethyl trimethoxysilane is/are used for silanation of the silicic acids, particularly such having a carbon content between 0.1 and 5.0 wt.-%, and preferably having a carbon content between 1.5 and 3.5 wt.-%. Of course, the compounds mentioned above can be used individually or in any desired combination with one another, specifically both in hydrophilic and in hydrophobized form. Furthermore preferably, the at least one reinforcing filler is present as a fiber-form or lamella-form filler, for example mineral fiber-form filler, or as a synthetic fiber-form filler.

Pyrogenic silicic acid having a BET surface of 35 m²/g±10 m²/g is particularly suitable as a semi-reinforcing filler e₃). In another embodiment of the invention, it is proposed to add silanated, pyrogenic silicic acid having a BET surface of 35 m²/g±10 m²/g, a carbon content of 1.5 to 3.5 wt.-%, and having a primary particle size of preferably greater than or equal to 40 nm to the dental materials as semi-reinforcing fillers e₃). Surprisingly, good mechanical workability and polishability of the dental material, for example with a dental miller, is achieved in this manner.

Preferably, the non-reinforcing filler e₄) is selected from among the group that consists of earth alkali metal oxides, earth alkali metal hydroxides, earth alkali metal fluoride, earth alkali metal carbonates, calcium apatite (Ca₅[(F, Cl, OH, ½CO₃) 1 (PO₄)₃], particularly calcium hydroxyl apatite (Ca₅[OH)|(PO₄)₃], titanium dioxide, zirconium oxide, aluminum hydroxide, silicon dioxide, precipitated silicic acid, calcium carbonate, boron silicate glass, glass containing barium oxide or lanthanum oxide, or lithium aluminum silicate glass. Examples of usable glass particles comprise barium, aluminum boron silicate glass, barium aluminum fluorosilicate glass, mixtures thereof, and the like. In these materials, barium can also be replaced by strontium and the like, and they can also contain fluoride. Other usable materials comprise calcium hydroxy ceramics and others, such as the fillers described in the U.S. Pat. Nos. 5,338,773; 5,710,194; 4,758,612; 5,079,277, and 4,814,362. These materials can have any morphology or shape, including that of spheres, regular or irregular shapes, filaments, whiskers, and the like. Preferably, such glass types are also silanated, although this is not necessary in the sense of the present invention. The filler particles can be treated with silane (coupled with silane) or provided with other treatments. Of course, the fillers mentioned above can be used individually or in any desired combination with one another, specifically also both in hydrophilic and in hydrophobized form.

The aforementioned nanoparticle fillers e₁), reinforcing fillers e₂), semi-reinforcing fillers e₃), and non-reinforcing fillers e₄) can be used both individually or in any desired combination with one another. In particular, the combinations e₁) with e₃), e₁), e₃) with e₄), and e₁), e₂), e₃) with e₄) have proven themselves to be particularly suitable with regard to their application technology properties, whereby the two last combinations mentioned are particularly preferred for a final crown and bridge material. For a temporary crown and bridge material, on the other hand, for cost reasons, either the combination e₁) with e₃) or e₃) alone is to be preferred. A particular advantage of the fillers or filler combination to be used according to the invention is that it is possible to do without the use of very expensive dental glass types, as they are usually used in dental composites, plastics, as well as crown and bridge materials, according to the state of the art. In order to keep polymerization shrinkage as low as possible, however, the greatest possible degrees of silicic acid filling should be implemented.

Furthermore, additives f), such as e.g. rheology modifiers, surfactants, opaques, color pigments, fluorescence dyes, phosphorescence dyes, and antioxidants can be added to the composition according to the invention, in each instance either alone or in any desired combination with one another.

The single-component dental materials according to the invention are particularly suitable for the production of (temporary) crowns and bridges. Preferably, the production of the (temporary) crowns and bridges takes place in that an impression of the tooth or teeth to be prepared is first produced, using a suitable impression material, with an impression tray with impression material distributed in it, or a (thermo)plastically deformable impression tray that is pressed against the jaw of which the impression is to be taken, before the tray is removed from the patient's mouth. Subsequently, the tooth in question is ground down by the dentist to form a tooth stump, which later functions as a support for the (temporary) crown or bridge. Then the single-component dental material according to the invention is filled into the impressions of the impression material, and the impression tray is repositioned on the tooth stump. Now photopolymerizatioon of the (temporary) crown and bridge material is initiated by means of irradiation with a light source, whereupon the material first passes through a plastic phase, and subsequently reaches an elastic phase, in which the material is sufficiently elastic, i.e. shape-stable, so that it can be removed from the patient's mouth without any undesirable deformation, but has not yet cured to such an extent that it can no longer be removed from the tooth stump, or can only be removed with great expenditure of force. After the temporary has been removed from the patient's mouth, it is end-treated, if necessary, and then cures completely, and can then be attached to the tooth stump. Alternatively to this, the material can be attached to the tooth stump after the end treatment, and cure there, if necessary after a second photoinitiation.

In order to guarantee efficient photoinitiation, it is provided, according to another preferred embodiment of the present invention, to use a translucent or transparent impression tray as well as a translucent or transparent impression material for taking the impression of the tooth or teeth to be prepared. A transparent material in the sense of the present invention is understood to mean a material that has an opacity of 0 to 70%, preferably 0 to 50%, particularly preferably 0 to 30%, and especially preferably 0 to 20%, with reference to a total layer thickness of 10 mm. This prevents a noteworthy part of the radiation applied to the impression tray during photoinitiation of the (temporary) crown and bridge material from being absorbed by the impression tray and/or the impression material contained in it.

### BRIEF DESCRIPTION OF THE DRAWING

Other objects and features of the present invention will become apparent from the following detailed description considered in connection with the accompanying drawing. It is to be understood, however, that the drawing is designed as an illustration only and not as a definition of the limits of the invention.

The single FIGURE schematically shows the three states of the dental material according to the invention.

### DETAILED DESCRIPTION OF THE PREFERRED EMBODIMENTS

Before exposure, the single-component dental material according to the invention, which can be used as a temporary crown and bridge material, is present in a first, plastic phase, during which the material can be deformed in any desired manner. In connection with the production of temporary crowns and bridges, for example, the dental material according to the invention is repositioned on the patient's jaw, for example in an impression tray, during the plastic phase, and this takes about 45 seconds. Because of the viscosity between 10 and 100,000 Pa·s provided according to the invention, as well as the consistency (analogous to ISO 4823) between 50 and 15 mm provided according to the invention, the dental material is sufficiently capable of flow, during the plastic phase, so that it can reproduce even tiny dental characteristics when repositioned on the jaw.

After repositioning on the patient's jaw, the dental material is exposed with an exposure period and/or exposure intensity that is less than that required for complete activation of the photoinitiator, for example for 10 seconds, after which the material passes through an elastic phase that lasts between 15 and 90 seconds, in which the material demonstrates a modulus of elasticity between 1 and 50 MPa. In this phase, the material can be removed from the patient's mouth again, without any additional, undesirable deformation occurring due to the great recovery during the elastic phase. In order to assure a sufficiently long working time during the elastic phase, the increase in the modulus of elasticity that begins after photoinitiation should amount to between 0.5 and 0.0001 MPa/sec, preferably between 0.3 and 0.001 MPa/sec, particularly preferably between 0.25 and 0.002 MPa/sec, and very particularly preferably less than or equal to 0.21 MPa/sec, during the elastic phase, per time unit.

After removal of the temporary from the patient's mouth, the dental material is exposed a second time, causing the part of the photoinitiator that was not yet activated to be converted to radicals and bringing about final curing to a duroplastic final state. Because of the modulus of elasticity provided according to the invention, of at least 1,000 MPa, and the bending strength provided according to the invention, of at least 90 MPa, the dental material demonstrates sufficient stability for a crown or bridge in the duroplastic phase.

### EXAMPLE 1

(Light-Curing (Temporary) Crown and Bridge Material According to the Invention, Having a Marked Elastic Time Phase, Using a Semi-Reinforcing Silicic Acid as Filler, and a Camphor Quinone/Dimethylaminobenzoic Acid Ethyl Ester Photoinitiator System)

0.28 parts D,L-camphor quinone and 0.01 parts dimethylaminobenzoic acid ethyl ester were dissolved, in a light-protected vacuum mixing beaker, in a mixture of 65 parts 2,2-bis-[4-hydroxy-3-methacryloyloxy-propoxy)phenyl]-propane (bis-GMA), 20 parts ethoxylated (10 EO) bisphenol A dimethacrylate (E10BADMA), 10 parts triethylene glycol dimethacrylate (TRGDMA), and 5 parts of a 1:1 isomer mixture of 7,7,9- and 7,9,9-trimethyl-4,13-dioxo-3,14-dioxa-5,12-diaza-hexadecane-1,16-d iol dimethacrylate (UDMA), respectively, and homogeneously mixed with 82 parts of a semi-reinforcing, highly disperse silicic acid surface-treated with methacryloxypropyl trimethoxysilane, having a BET surface of 35 m²/g, and a carbon content of 3%. To produce the tooth colors A1, A2, A3, A5, B1, B2, B3, and bleaching colors, color pigments as described in European Patent No. EP 0 836 845 B1 were used. The total content of hydroxyanisol and di-tert-butyl hydroxytoluene was 0.01 parts.

A homogeneous, plastically deformable, moderately flowing, translucent paste was obtained, which can be stored in light-protected primary packaging, such as tubes, syringes or cans, and is stable in storage for 24 months.

The paste was treated, in various phases, with visible light of an LED dental lamp (3M-Espe Freelight 100 mW/cm²), the individual phases through which the material passes up to its final curing were characterized, and the application technology properties of the cured material were determined, whereby the values reproduced in Tables 1 and 2 were obtained.

As is evident from Table 1, the light-curing single-component crown and bridge material passes through three different phases:

1. Plastic Time Phase:

Before the first exposure, the material was in a plastic time phase and demonstrated a viscosity of 100 Pas, i.e. a consistency of 32 mm. Therefore the material had an optimal flow capacity during this plastic time phase, which can be terminated at a desired point in time by means of exposure, and therefore can be as long as desired, so that it could be introduced into a shaping support, such as a molding material with an impression tray, or a thermoplastic dental tray, and flow against the prepared teeth or tooth stumps in the mouth.

2. Elastic Time Phase:

During and after a first exposure that lasted 10 seconds, the material made a transition from the plastic state described above into an elastic, deformable state. This elastic time phase lasted approximately 60 seconds. During the elastic time phase, the moduli of elasticity in the three-point bending test slowly increased at a rate of 0.03 MPa/sec, and were in a range between 10 and 30 MPa in this connection. The end of the elastic time phase could be recognized from the fact that the material became susceptible to breaking if additional mechanical stress was applied.

3. Duroplastic Time Phase:

After the end of the elastic time phase, the material was subjected to a second exposure having a duration of 160 seconds, whereby the material cured to a hard and impact-resistant composite, as is evident from the values reproduced in Tables 1 and 2. The final mechanical properties were achieved after 24 hours of storage in water at 35° C. (according to DIN EN ISO 10477).

From the above results, it is evident that the dental material according to the invention is excellently suitable for the production of (temporary) crowns and bridges.

Supplemental experiments using the material have shown that its characteristic properties are essentially independent of the exposure source used. Thus, the same results were obtained when the material was exposed with other commercially available dental polymerization lamps, such as Elipar Free Lights (400 mW/cm²), Optilux 501 (1500 mW/cm²), Elipar Tri Light® (700 mW/cm²), instead of the LED dental lamp (3M Espe Freelight 1000 mW/cm²).

### EXAMPLE 2

(Light-Curing (Temporary) Crown and Bridge Material According to the Invention, having a Marked Elastic Time Phase, Using a Filler Combination of a Semi-Reinforcing Silicic Acid and Nanoparticle Formulations Produced by Way of the Brine/Gel Method)

0.21 parts D,L-camphor quinone and 0.01 parts dimethylaminobenzoic acid ethyl ester were dissolved, in a light-protected vacuum mixing beaker, in 22.7 parts of a nanoparticle formulation produced by way of the brine/gel method, consisting of a mixture of 66% 2,2-bis-[4-hydroxy-3-methacryloyloxy-propoxy)phenyl]-propane (bis-GMA) and 34% triethylene glycol dimethacrylate (TRGDMA) with 50% silicon dioxide nanoparticles (average particle size 20 nm), as well as 5.3 parts of a nanoparticle formulation produced by way of the brine/gel method, of 80% of a 1:1 isomer mixture of 7,7,9-and 7,9,9-trimethyl-4,13-dioxo-3,14-dioxa-5,12-diaza-hexadecane-1,16-d iol dimethacrylate (UDMA), respectively, and 20% triethylene glycol dimethacrylate (TRGDMA) with 50% silicon dioxide nanoparticles (average particle size 20 nm), and 10.9 parts ethoxylated (10 EO) bisphenol A dimethacrylate (E10BADMA), and homogeneously mixed with 43 parts of a semi-reinforcing, highly disperse silicic acid surface-treated with methacryloxypropyl trimethoxysilane, having a BET surface of 35 m²/g, and a carbon content of 3%. The total content of hydroxyanisol and di-tert-butyl hydroxytoluene was 0.1 parts.

A homogeneous, plastically deformable, moderately flowing, translucent, slightly yellowish colored paste was obtained, which can be stored in light-protected primary packaging, such as tubes, syringes or cans, and is stable in storage for 24 months.

The paste was treated, in various phases, with visible light of an LED dental lamp (3M-Espe Freelight 1000 mW/cm²), the individual phases through which the material passes up to its final curing were characterized, and the application technology properties of the cured material were determined, whereby the values reproduced in Table 1 were obtained.

As is evident from Table 1, the light-curing single-component crown and bridge material according to the invention passes through the three different phases described in Example 1. During the elastic phase, the moduli of elasticity in the three-point bending test increased slightly more slowly, at a rate of 0.02 MPa/sec, than in the case of the material obtained in Example 1, whereby the moduli of elasticity in the three-point bending test were in a range between 15 and 35 MPa.

As is evident from the values reproduced in Table 1, the dental material obtained in Example 2 is also excellently suitable for the production of (temporary) crowns and bridges.

### EXAMPLE 3

(Light-Curing (Temporary) Crown and Bridge Material According to the Invention, having a Marked Elastic Time Phase, Using a Semi-Reinforcing Silicic Acid as a Filler and a Camphor Quinone/Dimethylaminobenzoic Acid Ethyl Ester/Hydroxyanisol Photoinitiator System)

A dental material was produced as in Example 1, with the exception that 1.0 part instead of 0.01 parts dimethylaminobenzoic acid ethyl ester, and 1.0 part instead of 0.01 parts hydroxyanisol were used.

A homogeneous, plastically deformable, moderately flowing, translucent paste was obtained, which can be stored in light-protected primary packaging, such as tubes, syringes or cans, and is stable in storage for 24 months.

The paste was treated, in various phases, with visible light of an LED dental lamp (3M-Espe Freelight 1000 mW/cm²), the individual phases through which the material passes up to its final curing were characterized, and the application technology properties of the cured material were determined, whereby the values reproduced in Table 1 were obtained.

As is evident from Table 1, the light-curing single-component crown and bridge material according to the invention passes through the three different phases described in Example 1. During the elastic phase, the moduli of elasticity in the three-point bending test increased slightly more slowly, at a rate of 0.01 MPa/sec, as compared to the materials obtained in Examples 1 and 2, whereby the moduli of elasticity in the three-point bending test were in a range between 15 and 35 MPa.

As is evident from the values reproduced in Table 1, the dental material obtained in Example 3 is also highly suitable for the production of (temporary) crowns and bridges.

A comparison of the properties of the materials obtained in Examples 1 and 3 surprisingly shows that there is an optimum in the particularly preferred ratio of photoinitiator a), co-photoinitiator b), and photoretarder c), at which a sufficiently long elastic phase with a sufficiently high modulus of elasticity is formed, on the one hand, and that in the duroplastic state, an optimum of mechanical/physical values, such as modulus of elasticity and bending strength, is also established.

### COMPARISON EXAMPLES 1 TO 4

Various commercially sold crown and bridge materials or dental composites, specified in greater detail in Table 1, were made to cure in accordance with the manufacturer's information, the individual phases through which the materials pass until their final curing were characterized, and the application technology properties of the cured materials were determined, whereby the values reproduced in Table 1 were obtained.

As is evident from the values reproduced in Table 1, the light-curing materials used in Comparison Examples 1 to 4 demonstrate significantly poorer properties than the masses obtained in Examples 1 to 3. The dental material used in Comparison Example 1, for example, has much too high a viscosity/consistency in the plastic phase to be optimally shaped by way of a shape carrier, i.e. not to deform the shape carrier because of the high viscosity/consistency. Therefore, an accurate, detailed reproduction of the original tooth shape cannot be guaranteed with this mass. The same also holds true for the product used in Comparison Example 4, in which the increase in the modulus of elasticity after the first exposure is furthermore extremely high, so that an elastic phase cannot form over a period of time that allows reasonable working.

In the case of the material used in Comparison Example 1, in the duroplastic end state, both the modulus of elasticity and the bending strength are furthermore too low to sufficiently withstand daily chewing stress even as a temporary. Furthermore, the materials used in the comparison examples demonstrate significantly poorer technical data, such as modulus of elasticity, bending strength, and Barcol hardness, than the dental materials obtained in Examples 1 to 3.

TABLE 1
Technical data relating to light-curing temporary crown and bridge materials in comparison
with temporary crown and bridge materials according to the state of the art

| | | | Elastic phase | | | | | |
|---|---|---|---|---|---|---|---|---|
| | | | | Increase in | Duration | Duroplastic end state | | |
| Example/ | Plastic phase | | Modulus of | modulus of | of elastic | Modulus of | Bending | |
| Comparison | Viscosity⁵⁾ | Consistency⁶⁾ | elasticity⁷⁾ | elasticity⁸⁾ | phase⁹⁾ | elasticity¹⁰⁾ | strength¹¹⁾ | Barcol |
| Example | (Pas) | (mm) | (MPa) | (MPa/s) | (s) | (MPa) | (MPa) | hardness¹²⁾ |
| Example 1 | 100 | 32 | 15.7 | 0.03 | 60 | 3012 | 97 | 72 |
| (according | | | | | | | | |
| to the | | | | | | | | |
| invention) | | | | | | | | |
| Example 2 | 400 | 24 | 22.3 | 0.02 | 65 | 4146 | 107 | 77 |
| (according | | | | | | | | |
| to the | | | | | | | | |
| invention) | | | | | | | | |
| Example 3 | 100 | 32 | 13.5 | 0.10 | 45 | 2700 | 90 | 70 |
| (according | | | | | | | | |
| to the | | | | | | | | |
| invention) | | | | | | | | |
| Comparison | 3,000,000 | 10 | 42.2 | 0.11 | 60 | 495 | 36 | 40 |
| Example 1¹⁾ | | | | | | | | |
| Comparison | 25 | 44 | 18.6 | 0.21 | 60 | 2516 | 67 | 55 |
| Example 2²⁾ | | | | | | | | |
| Comparison | 60 | 41 | 23.1 | 0.20 | 55 | 1924 | 82 | 51 |
| Example 3³⁾ | | | | | | | | |
| Comparison | 2,000,000 | 13 | 164.7 | 0.63 | 0 | 9596 | 121 | 87 |
| Example 4⁴⁾ | | | | | | | | |

¹⁾Light-curing temporary crown and bridge material Revotec LC from the company GC (Lot 0405111)
²⁾Automatically mixing temporary crown and bridge material Luxatemp Automix Plus from the company DMG (Lot 535784)
³⁾Automatically mixing temporary crown and bridge material Protemp 3 Garant from the company 3M Espe (Lot 187281)
⁴⁾Filling material Tetric Ceram from the company Ivoclar Vivadent (Lot F49546)
⁵⁾Measured with an air-mounted rotation viscosimeter, Haake RS 150, oscillation method, frequency 1 Hz, plate/plate system with a plate diameter of 20 mm, shear stress 500 Pa, as complex viscosity after a shear time of 45 seconds
⁶⁾Measured analogous to DIN EN ISDO 4823, Edition August 2001, Test Point 9.2 Consistency with a stress weight of 1500 g, a stress duration of 5 s
⁷⁾Modulus of elasticity in the three-point bending test analogous to ISO 10477, whereby the sample body rods were removed immediately after exposure and measured at 23° C.
⁸⁾The increase in modulus of elasticity is the incline in the modulus of elasticity/time diagram, within the elastic phase, determined by means of linear regression.
⁹⁾Is determined by means of practical deformability tests in comparison with established commercial products such as Luxatemp from the company DMG
¹⁰⁾Modulus of elasticity in the three-point bending test according to ISO 10477
¹¹⁾Bending strength in the three-point bending test according to ISO 10477
¹²⁾Barcol hardness according to DIN EN 59

TABLE 2
Millability and polishability of temporary
crown and bridge materials

| Crown and | Millability¹⁾, | Millability¹⁾, | |
|---|---|---|---|
| bridge | coarse | fine | |
| material | milling cutter | milling cutter | Polishability²⁾ |
| Example 1 | +++ | +++ | +++ |
| (according | Surface very | Surface very | Surface very |
| to the | smooth | smooth | smooth and shiny |
| invention) | and fine | and fine | |
| Comparison | ++ | ++ | + |
| Example 1 | | | Surface smooth, |
| [Revotek | | | not shiny |
| LC (GC)] | | | |
| Comparison | + | + | − |
| Example 2 | | | surface matte |
| [Luxatemp | | | |
| Automix plus | | | |
| (DMG)] | | | |
| Comparison | ++ | + | − |
| Example 3 | | | surface matte |
| [Protemp | | | |
| 3 Garant | | | |
| (M Espe)] | | | |

¹⁾Milling cutters from the company Meisinger: HM 77 GX 040 (coarse teeth), HM 79 FX 040 (fine teeth), speed of rotation: 20,000
²⁾Polishing tool from the company edenta: Exa Spezial R_{A} 0731 RA12, rubber R_{PM} max. 5000
+++ very good
++ good
+ satisfactory
− poor

Accordingly, while only a few embodiments of the present invention have been shown and described, it is obvious that many changes and modifications may be made thereunto without departing from the spirit and scope of the invention.

What is claimed is:

1. A photopolymerizable single-component dental material, comprising:
at least one compound adapted to be polymerized by photoinitiation; and
at least one photoinitiator,
wherein the dental material in a first, plastic state, has a viscosity of 10 to 100,000 Pa·s, or a consistency (analogous to ISO 4823) of 50 to 15 mm, and wherein after a first photoinitiation, makes a transition into an elastic state, in which the material has a modulus of elasticity between 1 and 50 MPa, such that the elastic state is maintained for at least 15 seconds, before the dental material reaches a duroplastic end state either directly or after a second photoinitiation, in which the material reaches a modulus of elasticity of at least 1,000 MPa and a bending strength of at least 90 MPa.

2. Single-component dental material according to claim 1, wherein in the first, plastic state, the material has a viscosity between 10 and 10,000 Pa·s and a consistency (analogous to ISO 4823) between 50 and 18 mm.

3. Single-component dental material according to claim 1, wherein the elastic state lasts over a period of 15 to 75 seconds.

4. Single-component dental material according to claim 1, wherein the material has a modulus of elasticity, measured analogous to ISO 10477, between 2 and 45 MPa during the elastic state.

5. Single-component dental material according to claim 1, wherein the increase in modulus of elasticity during the elastic phase amounts to between 0.5 and 0.0001 MPa/second.

6. Single-component dental material according claim 1, wherein the material reaches the duroplastic end state after a second photoinitiation, within 5 to 240 seconds.

7. Single-component dental material according to claim 1, wherein when the material is in the duroplastic end state, it has a modulus of elasticity in a bending test of greater than or equal to 2,000 MPa.

8. A single-component dental material according to claim 1, wherein when the material is in the duroplastic end state, it has a Barcol hardness greater than or equal to 40.

9. A single-component dental material according to claim 1, wherein the material contains:
a) 0.01 to 3 wt.-% of the at least one photoinitiator;
b) 0 to 10 wt.-%, of at least one co-photoinitiator;
c) 0.01 to 1.0 wt.-%, of at least one photoretarder or stabilizer;
d) 0.1 to 99 wt.-%, of the at least one photopolymerizable compound;
e1) 0 to 80 wt.-%, of at least one nanoparticle e1), having a particle size distribution between 5 and 35 nm;
e2) 0 to 60 wt.-%, of at least one reinforcing filler, said filler having a BET surface of at least 50 m²/g;
e3) 0 to 70 wt.-%, of at least one semi-reinforcing filler having a BET surface of 35 m²/g±10 m²/g;
e4) 0 to 90 wt.-%, of at least one non-reinforcing filler, having a grain size of 0.1 mm to 30 mm; and
f) 0-10% additives.

10. Single-component dental material according to claim 1, wherein the material contains:
a) 0.01 to 3 wt.-%, of the at least one photoinitiator, which is selected from the group consisting of camphor quinone and Lucirin TPO;
b) 0.01 to 1.0 wt.-%, of at least one photoretarder or stabilizer, said photoretarder or stabilizer being a compound selected from the group consisting of hydroxyanisol, di-tert-butyl hydroxytoluene, di-tert-butyl hydroxyanisol, and combinations thereof; and
c) the at least one photopolymerizable compound;
wherein a molar ratio of photoinitiator a) to photoretarder b) is between 0.5:1 and 250:1.

11. Single-component dental material according to claim 1, wherein the material comprises:
a) 0.01 to 3 wt.-%, of the at least one photoinitiator selected from the group consisting of camphor quinone and Lucirin TPO;
b) 0 to 10 wt.-%, of at least one co-photoinitiator selected from the group consisting of 4-dimethylaminobenzoic acid ethyl ester and 4-cyanoethyl aniline;
c) 0.01 to 1.0 wt.-%, of at least one photoretarder or stabilizer selected from the group consisting of hydroxyanisol, di-tert-butyl hydroxytoluene, di-tert-butyl hydroxyanisol, and combinations thereof; and
d) the at least one photopolymerizable compound, wherein a molar ratio of photoinitiator a) to co-photoinitiator b) is between 1:1 and 1:5, and a ratio of photoinitiator a) to photoretarder c) is between 1:1 and 1:25.

12. Single-component dental material according to claim 1, wherein the material comprises;
a) the at least one photoinitiator selected from the group consisting of camphor quinone and Lucirin TPO;
b) at least one co-photoinitiator selected from the group consisting of 4-dimethylaminobenzoic acid ethyl ester and/or 4-cyanoethyl aniline;
c) at least one photoretarder or stabilizer selected from the group consisting of hydroxyanisol, di-tert-butyl hydroxytoluene, di-tert-butyl hydroxyanisol, and combinations thereof, and;
d) the at least one photopolymerizable compound,
wherein a molar ratio of photoinitiator a) to co-photoinitiator b) is between 250:1 and 1:1, and a ratio of photoinitiator a) to photoretarder c) is between 75:1 and 1:1.

13. Single-component dental material according to claim 1, wherein the material further comprises a reinforcing filler comprising silanated, pyrogenic silicic acid having a BET surface of 35 m²/g±10 m²/g and a carbon content of 1.5 to 3.5 wt.-%.
